(19) United States
(12) Patent Application Publication
(10) Pub. No.: US 2025/0224012 A1
(43) Pub. Date: Jul. 10, 2025

(54) TWIN-TUBE DAMPER

(71) Applicant: AFCO Performance Group, LLC, Boonville, IN (US)

(72) Inventor: Donald R. Brackett, Fort Branch, IN (US)

(73) Assignee: AFCO Performance Group, LLC, Boonville, IN (US)

(21) Appl. No.: 18/406,358

(22) Filed: Jan. 8, 2024

(51) Int. Cl. F16F 9/26

(52) U.S. Cl. CPC F16F 9/26

(57) ABSTRACT

A twin-tube damper includes an outer cylinder with a lower mounting cap at a lower end of the outer cylinder and an upper cap at an upper end of the outer cylinder. An inner cylinder is concentrically arranged within the outer cylinder between the upper cap and the lower mounting cap. A reserve reservoir is defined by the annular volume between the outer cylinder and the inner cylinder. A piston rod extends to a piston head within the inner cylinder. A base is seated in a lower end of the inner cylinder, wherein the base includes valves which allow hydraulic fluid to flow between the compression reservoir and the reserve reservoir during the extension stroke and the rebound stroke. At least one passage is defined through the upper cap in combination with a check valve that only allows one-way fluid transfer from the reserve reservoir to the rebound reservoir.

### FIELD OF ENDEAVOR

The present disclosure relates in general to hydraulic suspension dampers, and specifically deals with fluid flow in twin-tube dampers.

### BACKGROUND

Hydraulic dampers are used in conjunction with automotive or vehicle suspension systems to absorb unwanted vibrations caused by the force applied from a road, rough terrain or surface while traveling over it. To absorb unwanted vibrations, dampers are generally connected between the body and the suspension of the vehicle. One end is mounted to the body and the other to the suspension. One mounting end is the piston end, which includes a piston rod extending into a pressure tube, with a piston head located within the pressure tube. The opposite end of the pressure tube is normally the opposite mounting end. The piston head divides the pressure tube into an upper working chamber or reservoir and a lower working chamber or reservoir both of which are typically filled with hydraulic fluid. Valves on the piston head define and control fluid flow through the piston head.

As used herein, fluid can mean either a liquid or a gas. Because the piston limits the flow of the hydraulic fluid between the upper and the lower working chambers when the damper is compressed or extended, the damper is able to produce a damping force which counteracts the force which would otherwise be transmitted from the suspension to the body of the vehicle and felt by the passengers of the vehicle. The piston head valves can be asymmetric for expansion and contraction, for example by using check valves. A piston with less fluid flow provides a firmer suspension and more control while a piston with more fluid flow leads to a softer ride but less control. Some dampers include adjustable valves to adjust the extension and/or rebound characteristics.

Shock absorbers or dampers are often categorized as monotube or twin-tube. A traditional twin-tube damper includes an inner cylinder and an outer cylinder, with a reserve reservoir annularly arranged between the two cylinders. A piston head mounted on a piston shaft is arranged to reciprocate within the inner cylinder. A base-valve is arranged at the end of the inner cylinder opposite the piston shaft. The interior of the inner cylinder is divided between a lower working chamber or compression reservoir and an upper working chamber or rebound reservoir. The interior of the inner cylinder is filled with a hydraulic fluid such as oil.

During the compression stroke in a twin-tube damper, and separate from fluid flow through the piston head, fluid exits from the compression reservoir through valves into the reserve reservoir. That fluid returns into the compression reservoir through a check device at the base during the rebound stroke. This exchange always takes place from the compression reservoir side to the reserve reservoir and back. As fluid exits the compression reservoir during compression, fluid also flows from the reserve reservoir to the upper working chamber or rebound reservoir in order to prevent negative pressures, and therefore negative damping forces, which occur during the subsequent rebound stroke.

Limitations of the traditional system exist in that the base valve generated pressure must always be greater than the main-piston pressure so that fluid replenishes into the rebound reservoir at an equal rate to fluid that exits through the base-valve. Maintaining this pressure balanced relationship can be difficult in production, and at all damping velocities, so compromises are often made during the build process.

Base-valve damping is typically over-pressured to compensate for these discrepancies which therefore results in a non-balanced damper. For a compression adjustable base-valve damper, which adjusts damping forces through the base-valve by changing bleed or spring rate, the over-pressure compensation requirement is even greater in order to maintain replenishment pressures at all possible adjustments. During normal, cyclical operation, these compromises can cause the damper to exhibit differences during the acceleration and deceleration phases of a cycle, otherwise known as hysteresis.

Thus, there is a need for improvement in this field.

### SUMMARY OF THE INVENTION

In a representative embodiment, a twin-tube damper includes an outer cylinder with a lower mounting cap at a lower end of the outer cylinder and an upper cap at an upper end of the outer cylinder. An inner cylinder is concentrically arranged within the outer cylinder between the upper cap and the lower mounting cap. A reserve reservoir is defined by the annular volume between the outer cylinder and the inner cylinder. The interior of the twin-tube damper is filled with a hydraulic fluid. A piston rod extends downward from a top end through a rod-guide passage in the upper cap to a piston head within the inner cylinder. The piston head divides an interior volume of the inner cylinder into a compression reservoir below the piston head and a rebound reservoir above the piston head. The piston head and shaft are arranged to slidably reciprocate relative to the inner cylinder during an extension stroke and a rebound stroke. A base is seated in a lower end of the inner cylinder, wherein the base includes valves which allow hydraulic fluid to flow between the compression reservoir and the reserve reservoir during the compression stroke and the rebound stroke. In certain embodiments, the upper cap includes an upper portion engaging an upper end portion of the outer cylinder, and a lower portion engaging an upper end portion of the inner cylinder. A lower surface is in communication with the rebound reservoir. A stepped portion extends between the upper portion and the lower portion, and is in communication with the reserve reservoir. At least one passage is defined through the upper cap in combination with a check valve that only allows one-way fluid transfer from the reserve reservoir to the rebound reservoir.

Another representative embodiment is a twin-tube damper having an outer cylinder with a lower mounting cap at a lower end of the outer cylinder and an upper cap at an upper end of the outer cylinder. An inner cylinder is concentrically arranged within the outer cylinder between the upper cap and the lower mounting cap. A reserve reservoir is defined by the annular volume between the outer cylinder and the inner cylinder. The inner cylinder and the reserve reservoir are filled with hydraulic fluid. A piston rod extends downward through the upper cap to a piston head within the inner cylinder, wherein the piston head divides an interior volume of the inner cylinder into a compression reservoir below the piston head and a rebound reservoir above the piston head, and wherein the piston head and shaft are arranged to slidably reciprocate relative to the inner cylinder during a compression stroke and a rebound stroke. A base is seated in a lower end of the inner cylinder. The base includes valves which allow hydraulic fluid to flow between the compression reservoir and the reserve reservoir. The upper cap engages an upper end portion of the outer cylinder and engages an upper end portion of the inner cylinder. At least one one-way passage is defined through the upper cap, wherein during the compression stroke, hydraulic fluid flows from the reserve reservoir into the rebound reservoir at the same rate that hydraulic fluid flows into the compression reservoir from the compression reservoir, and wherein during a rebound stroke, fluid is prevented from flowing from the rebound reservoir into the reserve reservoir.

Other objects and attendant advantages will be readily appreciated as the same become better understood by references to the following detailed description when considered in connection with the accompanying drawings.

### BRIEF DESCRIPTION OF THE DRAWINGS

FIG. 1 is a perspective view of a twin-tube damper according to an embodiment of the disclosure.

FIG. 2 is a cross-sectional view of the twin-tube damper of FIG. 1.

FIG. 3 is a cross-sectional view of the piston head in the twin-tube damper of FIG. 1.

FIG. 4 is a cross-sectional view of the base of the twin-tube damper of FIG. 1.

FIG. 5 is a cross-sectional view of the upper cap of the twin-tube damper of FIG. 1.

FIG. 6 is a perspective view of upper cap of the twin-tube damper of FIG. 1.

FIG. 7 is a vertical cross-sectional, semi-transparent view of the upper cap of FIG. 6.

FIG. 8 is a horizontal cross-sectional, semi-transparent view of the upper cap of FIG. 6.

FIG. 9 is an exploded view of the upper cap of FIG. 6.

### DETAILED DESCRIPTION OF THE DISCLOSURE

For the purpose of promoting an understanding of the principles of the disclosure, reference will now be made to the examples illustrated in the drawings and specific language will be used to describe the same. It will nevertheless be understood that no limitation of the scope of the disclosure is thereby intended. Any alterations and further modifications in the described examples, and any further applications of the principles of the disclosure as described herein are contemplated as would normally occur to one skilled in the art to which the disclosure relates. Certain examples of the disclosure are shown in detail; although it will be apparent to those skilled in the relevant art that some features which are not relevant to the present disclosure may not be shown for the sake of clarity.

Directional references herein are for ease of explanation and are not intended to be limiting.

The disclosed twin-tube damper addresses the limitations of a traditional system with passages and check valves that allow for an additional one-way hydraulic fluid, typically oil, transfer between the reserve reservoir and rebound reservoir. The passages are located in the piston rod-guide end of the damper opposite the base valves. The passages and check valves help equalize pressure imbalances by allowing fluid to replenish into the rebound reservoir at equal to or less than the rate it is exiting the compression reservoir through the base valves during the compression stroke. In alternate embodiments, the present disclosure can be used with triple tube dampers.

During a compression stroke, oil from the compression reservoir will flow through the base valves and into the reserve reservoir. Simultaneously, oil will flow through the main piston into the rebound reservoir to provide damping as well. An equal or lesser volume of the oil in the reserve reservoir will then flow through one or more check valves and into the rebound reservoir to help equalize pressure imbalances.

The resulting flow no longer limits the damper to base-valve dominant function only. This is especially beneficial in compression adjustable base-valve dampers as the limitations to adjustment range are much less when using the passage and the damper is much less susceptible to negative rebound damping pressure, and resulting negative rebound force. In addition, the damper is much less likely to exhibit signs of hysteresis during normal, cyclical operation.

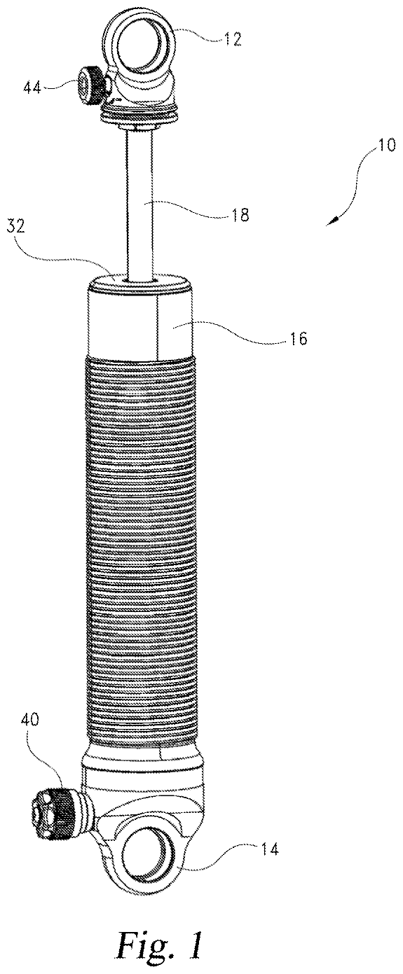

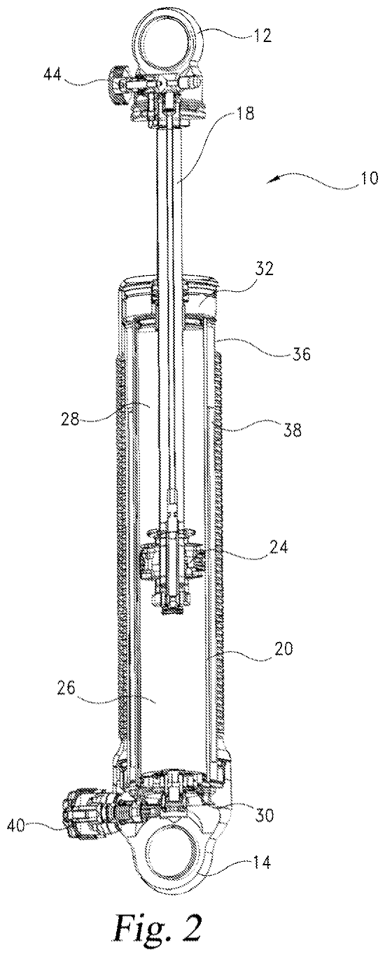

FIGS. 1-2 illustrate a twin-tube damper 10 which is designed to absorb and damp shock impulses. Damper 10 includes an outer cylinder 16 having an open upper end and an open lower end. The lower end is closed with lower mounting cap 14, which defines a lower attachment point. In certain embodiments, the outer cylinder 16 and lower mounting cap 14 may be manufactured as one piece. The upper end is closed with upper cap 32. Damper 10 includes a top mounting end 12 defining an upper attachment point. Piston rod or shaft 18 extends downward from upper end 12 and slidably through upper cap 32 to the interior of the damper. In the illustrated embodiment, the characteristics of damper 10 are adjustable using lower control 40 and upper control 44.

Inner cylinder 20 is visible in cross-sectional FIG. 2. Inner cylinder 20 has a smaller diameter than outer cylinder 16, and is concentrically arranged within outer cylinder 16 between upper cap 32 and lower mounting cap 14. The annular volume between outer cylinder 16 and inner cylinder 20 defines a reserve reservoir 36. A compressible gas bag 38 may be arranged in reserve reservoir 36.

Piston shaft 18 extends downward through upper cap 32 into inner cylinder 20 to piston head 24. The outer circular circumference of piston head 24, in combination with a seal, slidably engages the circular inner wall of inner cylinder 20, forming a fluid-tight barrier. Compression and rebound of twin-tube damper 10 causes piston shaft 18 and piston head 24 to reciprocate within inner cylinder 20. Piston head 24 divides the interior volume of inner cylinder 20 into a lower working chamber or compression reservoir 26 and an upper working chamber or rebound reservoir 28, respectively below and above the piston head. The position of piston head 24 defines the respective sizes of compression reservoir 26 and rebound reservoir 28.

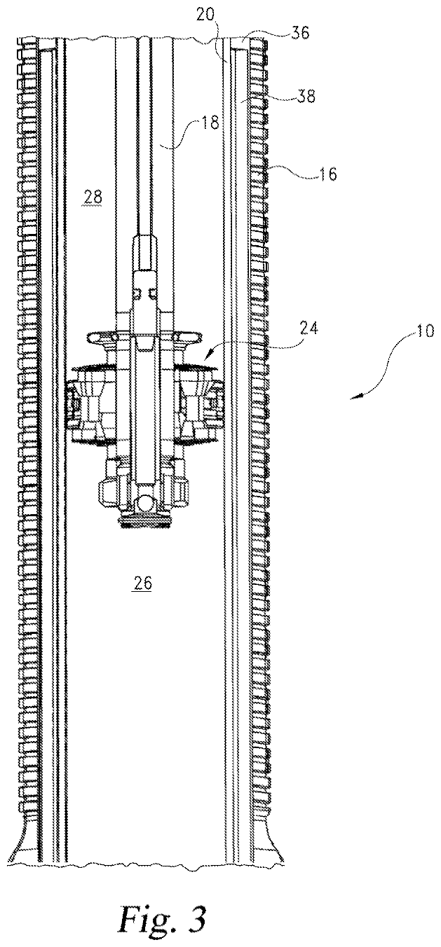

The interior of twin-tube damper 10 is typically filled with a hydraulic fluid such as oil, including fluid within compression reservoir 26 and rebound reservoir 28. Piston head 24, shown in cross-section in FIG. 3 may include valves or shims which allow hydraulic fluid to flow between compression reservoir 26 and rebound reservoir 28 during the respective compression and rebound strokes of twin-tube damper 10. The flow of fluid can be controlled using the piston head valves to define the damping characteristics of the damper. The piston head valves may be bi-directional or unidirectional using check-valves. In some embodiments, there are unidirectional piston head valves in one direction with different flow parameters than unidirectional piston head valves in the opposite direction.

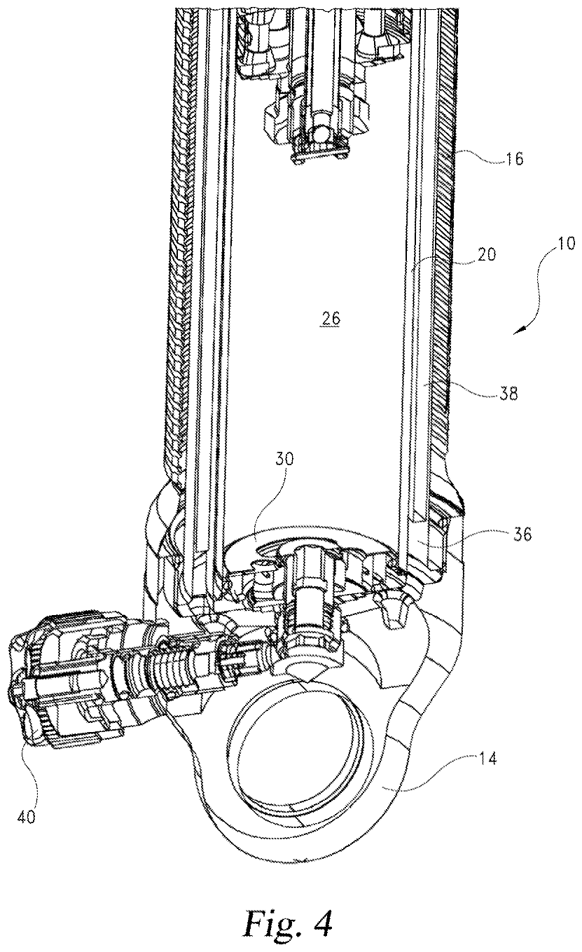

A base 30, shown in cross-section in FIG. 4, is seated in the lower end of inner cylinder 20 between inner cylinder 20 and lower mounting cap 14. Base 30 seals the lower end of the inner cylinder and separates it from reserve reservoir 36. Base 30 may include valves or shims which allow hydraulic fluid to flow between compression reservoir 26 and reserve reservoir 36 during the respective compression and rebound strokes of twin-tube damper 10. The lower ends of valves in base 30 are in communication with reserve reservoir 36. The base valves may be bi-direction or unidirectional using check-valves. In some embodiments, there are unidirectional base valves in one direction with different flow parameters than unidirectional base valves in the opposite direction.

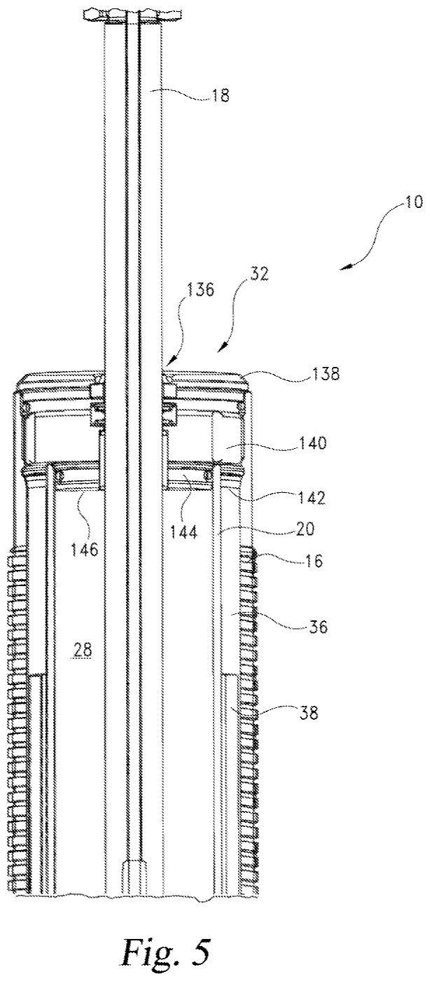

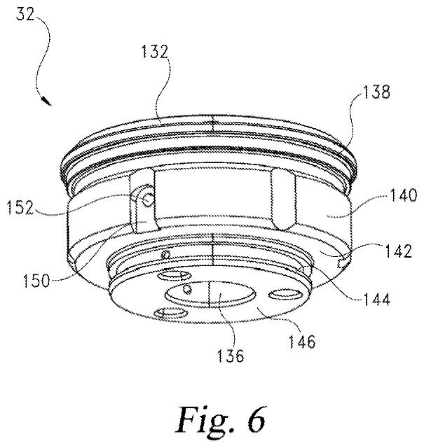

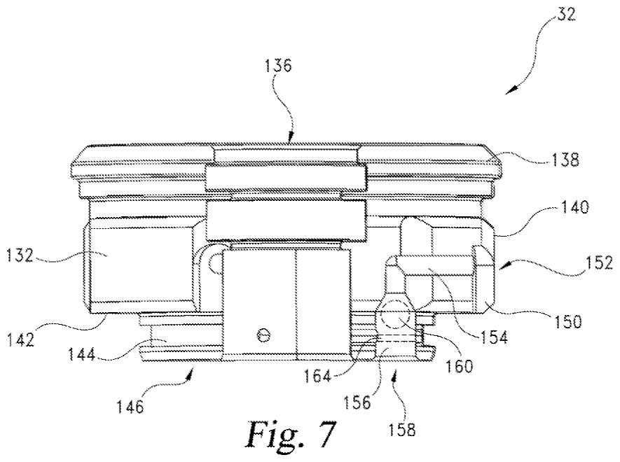

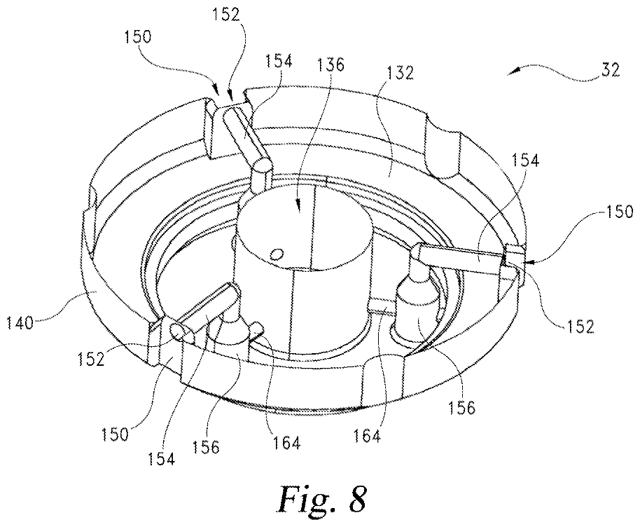

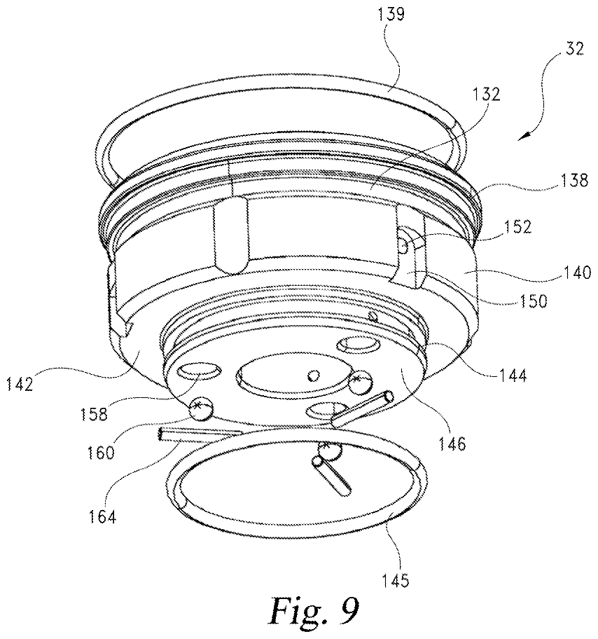

Upper cap 32 is shown in detail in FIGS. 5-9. Upper cap 32 includes a stepped cylindrical body 132. Piston rod-guide passage 136 is defined through upper cap 32. Body 132 includes an upper lip 138 and a larger upper diameter portion 140 which is in sealed engagement with the upper end and inner wall of outer cylinder 16, in conjunction with an upper O-ring 139. Body 132 further includes a smaller lower diameter portion 144 which extends into and is in sealed engagement with upper end of and inner wall of inner cylinder 20, in conjunction with lower O-ring 145. Lower diameter portion 144 includes a lower surface 146 in communication with rebound reservoir 28. Body 132 includes a stepped portion between upper diameter portion 140 and lower diameter portion 144. The stepped portion includes downward facing ring-shaped surface 142. Downward facing surface 142 extends between outer cylinder 16 and inner cylinder 20 and is in communication with reserve reservoir 36.

As illustrated in detail in FIGS. 5-9, body 132 includes at least one or more one-way passages with check valves that allow one-way oil transfer between the reserve reservoir and rebound reservoir. The illustrated embodiments include three one-way passages, although more or less can be included as desired.

For each one-way passage, a recessed portion 150 is defined in the side of upper outer diameter portion 140. The recessed portion 150 defines an open volume in communication with the reserve reservoir 36 and the corresponding passage. Each recessed portion 150 has a lower open end in lower surface 146, arranged so the recessed portion 150 is in communication with reserve reservoir 36. An orifice or port 152 is defined in body 132 in each recessed portion 150. In the illustrated embodiment, orifice 152 is the opening to pipe 154 which extends radially inward relative to piston shaft 18. In the interior of body 132, pipe 154 makes a ninety-degree downward turn toward lower diameter portion 144.

The lower end of pipe 154 connects to a cup-shaped portion 156. Cup-shaped portion 156 has an open lower end in communication with rebound reservoir 28. Cup-shaped portion 156 includes a cylindrical sidewall with a diameter larger than the diameter of pipe 154. A ring-shaped tapered or conical upper portion extends between the sidewall and the lower end of pipe 154. A check-valve stopper 160, such as a spherical ball, is arranged within cup-shaped portion 156. Fluid can flow in the direction from the pipe 154 into rebound reservoir 28 without being impeded by check-valve stopper 160. However, the check-valve stopper 160 is sized to float on the fluid and to matingly engage with the tapered portion to prevent fluid from flowing in the direction from the cup-shaped portion into pipe 154, forming a one-way check valve. A retaining piece 164, such as a radial pin, may be placed across the downward opening of the cup-shaped portion 156 to retain check-valve stopper 160 within cup-shaped portion 156.

During a compression stroke, some fluid may flow through valves in piston head 24, yet further fluid from the compression reservoir 26 flows through base 30 and into reserve reservoir 36. The one-way passages help equalize pressure imbalances by allowing fluid to replenish into the rebound reservoir up to the same rate it is exiting the compression reservoir through the base valves during the compression stroke. Corresponding to fluid flow into reserve reservoir 36, fluid will flow from reserve reservoir 36 into the rebound reservoir 28. This helps balance pressure created by the displacement of piston shaft 18 and the movement of piston head 24.

During the rebound stroke, fluid is prevented from flowing through the one-way passages from the rebound reservoir to the reserve reservoir. Fluid flow between the rebound reservoir and the compression reservoir during the rebound stroke is solely controlled by valves in piston head 24. During the rebound stroke, fluid can flow from the reserve reservoir to the compression reservoir at an amount equal to the displaced shaft volume.

The resulting flow no longer limits the damper to base-valve dominant arrangements. This is especially beneficial in compression adjustable base-valve dampers as the limitations to adjustment range are much less when using one-way passages and the damper is much less susceptible to negative rebound damping pressure, and resulting negative rebound force. In addition, the damper is much less likely to exhibit signs of hysteresis during normal, cyclical operation.

In certain embodiments, twin-tube damper 10 is adjustable. The present disclosure illustrates a lower control 40 which controls valves in base 30. The present disclosure further illustrates an upper control 44 which controls a valve needle within shaft 18. The position of the valve needle controls the damping characteristics of the valves in piston head 24. Controls 40 and 44 can be used to adjust the damping characteristics of the compression stroke and the rebound stroke. Controls 40 and 44 can be manually, electronically, pneumatically or hydraulically controlled.

The primary components of damper 10 are formed from materials which are conventional for use with shock absorbers, including but not limited to, carbon steel, aluminum, stainless steel, composite materials, rubber O-rings or the like.

While the disclosure has been illustrated and described in detail in the drawings and foregoing description, the same is to be considered as illustrative and not restrictive in character, it being understood that only the preferred example has been shown and described and that all changes, equivalents, and modifications that come within the spirit of the disclosures defined by following claims are desired to be protected.

1. A twin-tube damper, comprising:
a. an outer cylinder, a lower mounting cap at a lower end of the outer cylinder and an upper cap at an upper end of the outer cylinder;
b. an inner cylinder concentrically arranged within the outer cylinder between the upper cap and the lower mounting cap;
c. a reserve reservoir defined by an annular volume between the outer cylinder and the inner cylinder,
d, wherein the twin-tube damper is filled with a hydraulic fluid;
e. a piston rod extending downward from a top end through a rod-guide passage in the upper cap to a piston head within the inner cylinder, wherein the piston head divides an interior volume of the inner cylinder into a compression reservoir below the piston head and a rebound reservoir above the piston head, wherein the piston head and shaft are arranged to slidably reciprocate relative to the inner cylinder during a compression stroke and a rebound stroke;
f. a base seated in a lower end of the inner cylinder, wherein the base includes valves which allow hydraulic fluid to flow between the compression reservoir and the reserve reservoir during the compression stroke and the rebound stroke;
g. the upper cap including an upper portion engaging an upper end portion of the outer cylinder, and a lower portion engaging an upper end portion of the inner cylinder and wherein the lower portion defines a lower surface in communication with the rebound reservoir;
h. a stepped portion extending between the upper portion and the lower portion, the stepped portion in communication with the reserve reservoir; and
i. at least one passage defined through the upper cap in combination with a check valve that only allows one-way fluid transfer from the reserve reservoir to the rebound reservoir.

2. The twin-tube damper of claim 1, comprising a plurality of passages defined through the upper cap, wherein each passage only allows one-way fluid transfer from the reserve reservoir to the rebound reservoir.

3. The twin-tube damper of claim 1, wherein the stepped portion includes a ring-shaped downward facing surface.

4. The twin-tube damper of claim 1, including a recessed portion defined in the upper portion, wherein the recessed portion defines a volume in communication with the reserve reservoir and a pipe forming the at least one passage.

5. The twin-tube damper of claim 4,
a. wherein the pipe connects to a cup-shaped portion having an open lower end in communication with the rebound reservoir;
b. the cup-shaped portion having a cylindrical sidewall with a diameter larger the diameter of the pipe and a ring-shaped tapered portion extending between the sidewall and the lower end of the pipe; and
c. a check-valve stopper arranged within the cup-shaped portion.

6. The twin-tube damper of claim 5, wherein the check-valve stopper is a spherical ball.

7. The twin-tube damper of claim 1, wherein the piston head includes adjustable piston head valves.

8. The twin-tube damper of claim 7, wherein the piston valves comprise unidirectional piston head valves in one direction with different flow parameters than unidirectional piston head valves in the opposite direction.

9. The twin-tube damper of claim 7, wherein the base includes adjustable base valves.

10. The twin-tube damper of claim 1, wherein during a compression stroke, hydraulic fluid flows from the reserve reservoir into the rebound reservoir at a rate less than or equal to the rate that hydraulic fluid flows into the reserve reservoir from the compression reservoir, and wherein during a rebound stroke, fluid is prevented from flowing from the rebound reservoir into the reserve reservoir.

11. A twin-tube damper, comprising:
a. an outer cylinder having an upper end and a lower end;
b. a lower mounting cap at the lower end of the outer cylinder, the lower mounting cap defining a lower attachment point;
c. an upper cap at the upper end of the outer cylinder;
d. an inner cylinder concentrically arranged within the outer cylinder between the upper cap and the lower mounting cap;
e. a reserve reservoir defined by an annular volume between the outer cylinder and the inner cylinder;
f. a top mounting end defining an upper attachment point;
g. a piston rod extending downward from the top mounting end and slidably extending through a rod-guide passage in the upper cap to a lower end located in an interior of the inner cylinder;
h. a piston head mounted to the lower end of the piston rod, wherein a perimeter of the piston head slidably engages an inner wall of the inner cylinder, and wherein the piston head divides an interior volume of the inner cylinder into a compression reservoir below the piston head and a rebound reservoir above the piston head;
i. a base seated in a lower end of the inner cylinder between the inner cylinder and the lower mounting cap, wherein the base includes valves which allow hydraulic fluid to flow between the compression reservoir and the reserve reservoir during the respective compression and rebound strokes of the twin-tube damper;
j. the upper cap including a body with an upper diameter portion in sealed engagement with the upper end and an inner wall of the outer cylinder, and a lower diameter portion which extends into and is in sealed engagement with an upper end and the inner wall of the inner cylinder wherein the lower diameter portion includes a lower surface in communication with the rebound reservoir;
k. the body including a stepped portion between the upper diameter portion and the lower diameter portion, the stepped portion defining a downward facing surface in communication with the reserve reservoir; and
l. a one-way passage defined through the upper cap that only allows fluid transfer from the reserve reservoir into the rebound reservoir.

12. The twin-tube damper of claim 11, comprising a plurality of passages defined through the upper cap in combination with check valves, wherein each passage allows one-way fluid transfer from the reserve reservoir to the rebound reservoir.

13. The twin-tube damper of claim 11, wherein the stepped portion includes a ring-shaped downward facing surface.

14. The twin-tube damper of claim 11, wherein the one-way passage includes a pipe with an orifice in communication with the reserve reservoir, wherein the pipe connects to a cup-shaped portion having an open lower end in communication with the rebound reservoir, and a check-valve stopper arranged within the cup-shaped portion.

15. The twin-tube damper of claim 11, wherein the piston head includes adjustable piston head valves.

16. The twin-tube damper of claim 15, wherein the piston head valves comprise unidirectional piston head valves in one direction with different flow parameters than unidirectional piston head valves in the opposite direction.

17. The twin-tube damper of claim 15, wherein the base includes adjustable base valves.

18. A twin-tube damper, comprising:
a. an outer cylinder with a lower mounting cap at a lower end of the outer cylinder and an upper cap at an upper end of the outer cylinder;
b. an inner cylinder concentrically arranged within the outer cylinder between the upper cap and the lower mounting cap;
c. a reserve reservoir defined by an annular volume between the outer cylinder and the inner cylinder, wherein the inner cylinder and the reserve reservoir are filled with hydraulic fluid;
d. a piston rod extending downward from a top end through a rod-guide passage in the upper cap to a piston head within the inner cylinder, wherein the piston head divides an interior volume of the inner cylinder into a compression reservoir below the piston head and a rebound reservoir above the piston head, wherein the piston head and shaft are arranged to slidably reciprocate relative to the inner cylinder during a compression stroke and a rebound stroke;
e. a base seated in a lower end of the inner cylinder, wherein the base includes base valves which allow hydraulic fluid to flow between the compression reservoir and the reserve reservoir;
f. the upper cap engaging an upper end portion of the outer cylinder and engaging an upper end portion of the inner cylinder; and,
g. at least one one-way passage defined through the upper cap, wherein during the compression stroke, hydraulic fluid flows from the reserve reservoir into the rebound reservoir through the one-way passage at the same rate that hydraulic fluid flows through the base valves into the reserve reservoir from the compression reservoir, and wherein during a rebound stroke, fluid is prevented from flowing from the rebound reservoir into the reserve reservoir.

19. The twin-tube damper of claim 18, wherein the base includes adjustable base valves.

20. The twin-tube damper of claim 19, wherein the piston head includes adjustable piston head valves.
